(19) United States
(12) Patent Application Publication
(10) Pub. No.: US 2017/0145934 A1
(43) Pub. Date: May 25, 2017

(54) DRIVE DEVICE FOR A MOTOR VEHICLE, MOTOR VEHICLE HAVING SUCH A DRIVE DEVICE, AND COMPUTER SOFTWARE PRODUCT FOR ACTUATING THE DRIVE DEVICE

(71) Applicant: GM GLOBAL TECHNOLOGY OPERATIONS LLC, Detroit, MI (US)

(72) Inventors: Stephan-Johannes SCHNORPFEIL, Ruesselsheim (DE); Claus Juergen GLAHN, Ruesselsheim (DE)

(73) Assignee: GM GLOBAL TECHNOLOGY OPERATIONS LLC, Detroit, MI (US)

(21) Appl. No.: 15/357,288

(22) Filed: Nov. 21, 2016

(30) Foreign Application Priority Data
Nov. 19, 2015 (DE) 202015008000.6

(51) Int. Cl. F02D 41/00; F02D 41/26; F02B 37/14; F02D 41/06

(52) U.S. Cl. CPC F02D 41/0007; F02D 41/062; F02D 41/26; F02B 37/14

(57) ABSTRACT

A drive device is disclosed for a motor vehicle having a combustion engine, a feed line for supplying combustion air to the combustion engine, and a compressor unit cooperating with the feed line for compressing combustion air for the combustion engine. One or more torque generators are operable independently of the combustion engine and selectively coupled to the compressor unit. A control unit is configured to actuate the torque generator in such manner that the torque generator drives the compressor unit at least for a time before the start of the combustion engine.

### CROSS-REFERENCE TO RELATED APPLICATION

This application claims priority to German Patent Application No. 202015008000.6, filed Nov. 19, 2015, which is incorporated herein by reference in its entirety.

### TECHNICAL FIELD

The present disclosure relates to a drive device for a motor vehicle and a motor vehicle equipped with a drive device of such kind. The present disclosure further relates to a computer software product for actuating the drive device.

### BACKGROUND

Modern drive devices include a combustion engine, for example a four-stroke gasoline or diesel engine, in which the combustion air is compressed under a greater pressure than atmospheric pressure in order to increase output. Depending on its design, the drive device includes one or more, typically two compression stages. Drive devices with one compression stage usually include a turbocharger device or a compressor unit with a compressor. Drive devices with two compression stages include either two turbocharger devices or one turbocharger device and one compressor unit. The turbocharger device is driven fluidically by the enthalpy contained in the exhaust gases from the combustion engine. The compressor unit is driven mechanically, either by the combustion engine itself or by an additional motor, an electric motor (“e-charger”) for example. Combustion engines in which the combustion air is compressed are often also called “charged” combustion engines.

A significant feature that sets a compressor unit driven by an electric motor apart from a turbocharger device is that the compressive power delivered is not dependent on the exhaust gas enthalpy released by the combustion engine. The low compressive power resulting from the turbocharger device operating at low rotating speeds of the combustion engine and the correspondingly poor response behavior of the combustion engine are often called turbo lag. It therefore follows that, while the response behavior of the combustion engines can be improved with a compressor unit that is driven by an electric motor, the electric motor must then deliver a certain output in order to bring the compressor up to the optimum rotating speed, leading to greater consumption of electrical energy. Since the electrical energy is provided by a generator which is driven by the combustion engine, the greater consumption of electrical energy also leads to increased fuel consumption. Particularly in the context of efforts to reduce CO₂ emissions, the increased fuel consumption by combustion engines with one or two compression stages is undesirable.

In many respects, the start phase of the combustion engine is critical for fuel consumption. The start phase includes the speed range of the combustion engine from standstill to idling speed. A certain amount of energy is lost here simply in overcoming the mass inertia of the moving parts in the combustion engine, particularly the pistons and the moving parts of the drivetrain, such as the crankshaft and transmission and the friction thereof. This energy is typically provided by the starter, which in most cases is powered from an electrical energy storage device, usually a battery. This storage device is charged by a generator, which is driven by the combustion engine, so that some of the fuel is required for starting the combustion engine without the combustion engine delivering any usable torque. The problems associated with the start phase are aggravated in a cold start, because then the engine oil also has a relatively high viscosity, and so offers still greater resistance to the starter. The colder the ambient temperature, the more viscous the engine oil becomes, and the resistance the starter must overcome is correspondingly greater. The situation is further complicated by the fact that the battery also loses its charge more quickly in low temperatures, to the point that it may not be able deliver sufficient voltage to activate the starter so that it is able to provide the torque needed to start the combustion engine. At the very least, the phase of starting the combustion engine is made longer, making the starting operation inconvenient.

But the mass inertia and friction described earlier must still be overcome in a warm start, and this is important in modern motor vehicles because they are equipped with start-stop systems, which switch the combustion engine off when the motor vehicle is stationary and the ignition is active, for example when the motor vehicle is waiting at a red traffic light, a closed level crossing or when turning at an intersection.

A further aspect to be considered when starting a combustion engine is the fact that air pressure diminishes with increasing geodetic height. As a result of the lower air pressure, the quantity of combustion air that is introduced into the combustion chamber of the combustion engine is also reduced. The power that the combustion engine can develop is also reduced correspondingly, and this too prolongs the start phase and makes it less convenient.

### SUMMARY

In accordance with the present disclosure a drive device for a motor vehicle is provided, which lowers fuel consumption in the start phase of the combustion engine during both a warm start and a cold start. Moreover, the start phase may also be shortened particularly during a cold start and/or at great geodetic heights, to make starting the engine more convenient.

One embodiment of the present disclosure relates to a drive device for a motor vehicle, having a combustion engine, a feed line for feeding combustion air to the combustion engine, and a compressor unit that cooperates with the feed line to compress combustion air for the combustion engine. One or more torque generators are operable independently of the combustion engine and may be connected operatively to the compressor unit, and with which the compressor unit may be driven. A control unit acts in controlling manner on the torque generator to such effect that the torque generator drives the compressor unit at least for a period before the combustion engine starts. The compressor unit may include any suitable type of compressor, although rotary compressors are particularly suitable. Torque generators that are operable independently of the combustion engine must be able to drive the compressor unit even when the combustion engine is stationary. Compressor units are known that are driven mechanically to compress the combustion air from the combustion engine itself. Turbocharger devices are also known that use a turbocompressor to compress the combustion air. The turbocompressor is driven fluidically by an exhaust gas turbine which is itself powered by the exhaust gases of the combustion engine. In both cases, however, the combustion engine must be operating before the combustion air can be compressed. In this respect, it is not possible to refer to torque generators that can be operated independently of the combustion engine.

Since the control unit actuates the torque generator in such manner that it drives the compressor unit at least for a period before the combustion engine is started, the combustion engine is already supplied with precompressed combustion air, when the piston first begins to move when starting. Because of the precompressed combustion air, the quantity of combustion air that is introduced into the combustion chamber of the combustion engine and thus also the cylinder charge is increased. Consequently, correspondingly more fuel may also be injected. This in turn increases the amount of chemical energy that can be converted into mechanical energy by igniting the mixture of fuel and combustion air. Consequently, the rotating speed of the combustion engine can be increased more quickly than when the combustion chamber is charged with uncompressed combustion air. The mass inertia of the moving parts of the combustion engine, particularly the mass inertia of the pistons and the moving part of the drivetrain, particularly the crankshaft and the transmission, and the friction thereof, can also be overcome more rapidly in this way, so that the entire start phase of the engine, i.e., from standstill to idling speed, may be shortened. These advantages may be realized particularly effectively in a cold start, because then the engine oil is relatively viscous, and the friction described previously is particularly strong. However, the advantages are also evident in a warm start, because the inertia and the friction described earlier still have to be overcome in these circumstances, though to a lesser degree than in a cold start.

Since the combustion air drawn in from the surrounding atmosphere is compressed, even at great geodetic heights the combustion air is supplied to the combustion engine in sufficient quantity to ensure that the combustion engine is able to deliver a powerful turning moment even in the starting phase, so that it reaches idling speed quickly, and the starting phase is made shorter.

A further technical effect may be realized by compressing the combustion air before the combustion engine is started. In particular, the fuel may be more or less volatile depending on its quality, wherein fuel of poorer quality tends to vaporize less readily, meaning that the fuel only begins to vaporize under higher pressures than fuel of better quality. Since the combustion air has been precompressed with the compressor unit and is subsequently compressed by the piston, not only is the fuel injected into very highly compressed combustion air, but the air is also significantly warmer because of the compression, even during a cold start and at low ambient temperatures. Both effects help to ensure that even fuel of lower quality vaporizes quickly.

If the combustion air is not precompressed by the compressor unit, the fuel is injected into the less intensively compressed combustion air, which is also colder. In the case of less volatile fuel, therefore, only a part of the fuel of is vaporized, the rest condenses on the wall of the cylinders, and is not available for use in the ignitable mixture of fuel and combustion air. Accordingly, there is less chemical energy available, and the start phase is longer. To counteract this effect, more fuel can be injected, so that saturation of the combustion air in the combustion chamber is achieved and more fuel is vaporized. However, while this ensures that more chemical energy is available, more fuel is needed. This drawback is alleviated considerably with the use of the precompressed combustion air from the compressor unit according to the suggestion.

The control unit is able to actuate the torque generator in such manner that the compressor unit is activated between 0.5 and 2 seconds before the combustion engine is started.

In an alternative embodiment, the torque generator may be in the form of an electric motor with which the compressor unit may be operatively connected. Electric motors are often used to drive compression equipment and are particularly suitable for use as a torque generator that is not dependent on the combustion engine. The electric motor may be operated via a storage device for electrical energy that is charged while the motor vehicle is in operation. Accordingly, the electric motor may also be operated with the electrical energy stored in the storage device even when the combustion engine has not been started. The electric motor has the further advantage in that its delivery of the torque required to drive the compressor unit is largely uninfluenced by its rotating speed.

In another embodiment, the control unit may act on the torque generator in such manner that the torque generator no longer drives the compressor unit for a brief period during or after the start of the combustion engine. It has been found that most of the technical effects and advantages described in the preceding text can be achieved even if the compressor unit is only operated for a relatively short period of time. Thus, it is sufficient to activate the compressor unit by the torque generator for example 0.5 to 2 seconds before the combustion engine is started, and to deactivate the compressor unit during or shortly after the start. In this context, the time for which the compressor unit is operated after the start may be shorter than the time before the start. For example, the control unit may actuate the torque generator such that the compressor unit is deactivated when the combustion engine has made between 1 and 10 revolutions. The shorter the time for which the compressor unit is in operation, the less energy is required, which in turn lowers fuel consumption. Accordingly, the time for which the combustion engine is started later, after the ignition has been actuated, is very short, so that the user of the motor vehicle scarcely notice the activation of the compressor unit as suggested, before combustion engine is started properly. On the other hand, the user will note with satisfaction that the combustion engine has reached idling speed very quickly, regardless of its geodetic height or the outside temperature.

In a further embodiment, the drive device may include a starter for starting the combustion engine, and the control unit may actuate the torque generator and the starter in such manner that the torque generator drives the compressor unit at least for a short time before the combustion engine is started, and no longer drives the compressor unit when the combustion engine is being started or after it is started. The concept presented here is also suitable for combustion engines which do not have a starter. However, combustion engines which can be started without a starter require the use of a relatively sophisticated electronic controller, at least of the combustion engine and the inlet valves, so combustion engines of this kind have not found popular use as of the priority date of this application.

Starters that are used to start combustion engines usually include an electric motor, configured to drive the crankshaft. The crankshaft also serves to open the inlet valves so that the precompressed combustion air can flow into the combustion chamber. The electric motor of the starter can be actuated simply by the control unit in such manner that the technical effects described earlier are maximized. From a technical point of view, the starter may be integrated in the control circuit with minimal additional effort. Moreover, the turning moment the electric motor of the starter must apply to the crankshaft in order to start the combustion engine may be set lower for the following reason: As was indicated earlier, the amount of chemical energy that can be converted into mechanical energy in the combustion chamber is increased because more fuel can be added to the compressed combustion air. Because there is more chemical energy available, the amount of mechanical energy that can be converted therefrom also increases, so that from the very first work cycle the combustion engine delivers a larger turning moment than is the case with a supply of uncompressed combustion air. As a direct consequence of this, the starter only needs to deliver a smaller turning moment to the crankshaft, essentially just enough to open the inlet valves and allow an ignitable mixture of combustion air and fuel into the combustion chamber. Accordingly, the starter may be made smaller. A smaller starter represents a smaller drain on the on-board voltage, which means that the on-board voltage drops less when the starter is switched on than for known starters. This particularly has the following technical effect: As indicated earlier, modern motor vehicles are fitted with a start-stop system which switches the combustion engine off when the ignition is activated and the motor vehicle is stationary, at a closed level crossing, for example. However, the other consumers in the motor vehicle, such as the on-board electronics, the radio or the air conditioning system to mention just a few, still remain active. But when it is in the switched-off condition, the combustion engine is not able to charge the electrical energy storage device, and the on-board voltage falls as time goes on. But the starter only needs a minimum voltage in order to be able to restart the combustion engine. In order to prevent the on-board voltage from dropping to the point that the combustion engine can no longer be started by the starter, the control unit switches the combustion engine on again if the on-board voltage falls below the minimum voltage, even if the combustion engine is not yet needed to move the motor vehicle since the level crossing is still closed.

However, since the compressed combustion air and the associated effects thereof as described earlier in this document, the starter may be made with smaller dimensions and it also requires less voltage to be able to restart the combustion engine reliably. Consequently, the combustion engine does not have to be restarted until later, and fuel consumption is reduced.

It should be noted at this point that the significantly higher energy density of the fuel compared with the electrical energy storage device means that the extra consumption of electrical energy required by a compressor unit that is driven by an electric motor is overcompensated by the additional injected fuel (“thermodynamic amplifier”). Consequently, the fuel makes a considerable quantity of energy available for starting the combustion engine, which energy does not have to be supplied by the electrical energy storage device. This in turn relieves the burden on the storage means and after a prolonged stationary period of the motor vehicle the combustion engine does not need to be restarted until later compared with a drive device without compressed combustion air, and this too can save fuel.

One embodiment is noteworthy because the drive device is equipped with a coupling device, via which the torque generator may optionally be connected to the compressor unit. As was indicated earlier, the effect of the compressor unit is to compress the combustion air so that the mass inertia of the moving parts of the combustion engine and of the drivetrain parts connected thereto is overcome sooner. However, in order for this to take place the compressor unit must be able to compress the combustion air to the requisite pressure within a short time. Depending on which torque generator is used, it may be that the torque generator must itself reach a certain rotating speed before it can deliver the necessary turning moment. In this case, it may be advisable to arrange the coupling device between the torque generator and the compressor unit, so that the torque generator is not connected to the compressor unit until the torque generator is turning at the required speed. The torque generator and the compressor unit may also be disconnected from each other more quickly, when the combustion air no longer has to be compressed, for example.

In a further embodiment, the control unit has an actuating effect on the coupling device and/or the torque generator in such manner that the torque generator drives the compressor unit briefly before the combustion engine starts, and no longer drives the compressor unit while the combustion engine is being started or thereafter. As was explained previously, the coupling device serves to ensure a rapid connection and disconnection between the torque generator and the compressor unit. To this extent, the time for which the compressor unit compresses the combustion air may be controlled very precisely by means of the coupling device. It is therefore not necessary to use torque generators that can be accelerated and decelerated again very quickly. In particular, the torque generators may be actuated in such manner that they are accelerated to their optimum turning speed before being connected to the compressor unit, and so can deliver the necessary output to the compressor unit immediately. The use of the coupling device thus makes it possible to provide a drive device with very rapid response capability.

In an alternative variant, the starter and/or the torque generator are actuated in such manner that the torque generator drives the compressor unit temporally at least before the combustion engine is started, and no longer drives the compressor unit while the combustion engine is being started or thereafter. The turning moment the electric motor of the starter must apply to the crankshaft to start the combustion engine may be set lower for the reasons described previously and the starter may be of smaller dimensions. A smaller starter represents a smaller burden on the on-board voltage, which means that the on-board voltage drops less when the starter is switched on than for known starters. Consequently, the combustion engine can remain switched off for longer, including during prolonged waiting times, at a closed level crossing for example.

In an alternative embodiment, a turbocharger device is provided with a turbocompressor and an exhaust gas turbine which drives the turbocompressor. The turbocompressor cooperates with the feed line and is positioned upstream of the compressor unit in the feed direction of the combustion air, and the exhaust gas turbine is arranged in a drainage pipe of the drive device. The combination of compressor unit and turbocharger device makes it possible to compress the combustion air to even greater pressures, which means that the combustion engine may be operated under still greater loads. Since two differently driven compressor types are used, which deliver their maximum compressive power at different turning speeds of the combustion engines, an overall more uniform compression over the speed range of the combustion engine is achieved. The rotating speed of the turbocharger device depends on the enthalpy contained in the exhaust gas. A waste gate line may also be provided, with which it is possible to change the quantity of exhaust gas that flows through the waste gate line and through the exhaust gas turbine. This in turn also enables the rotating speed of the turbocompressor to be adjusted within certain limits. It should be noted again at this point that the turbocharger device delivers a compressive power that is dependent on the speed of the combustion engine. Therefore, a turbocharger device is not a torque generator that can be operated independently of the combustion engine. To this extent, the turbocharger device provides additional compression which can supplement but not replace the compressor unit for the purpose of implementing the concept according to the suggestion.

One variation of the present disclosure relates to a motor vehicle with a drive device according to one of the preceding embodiments. The technical effects and advantages that may be realized with the motor vehicle according to the suggestion, are analogous to those discussed with respect to the drive device according to the suggestion. In summary, it should be noted that the mass inertia and friction of the moving parts in the combustion engine and the moving parts in the drivetrain can be overcome more quickly when the combustion engine is started, with the result that the starting phase of the combustion engine can be shortened. These advantages may be realized particularly effectively in a cold start, because the engine oil is relatively viscous, and the friction described previously is particularly strong. However, the advantages may also be realized in a warm start, because the inertia and friction described earlier have to be overcome in these conditions too, though to a lesser degree than in a cold start. All of the technical effects and advantages described result either directly or indirectly in reduced fuel consumption and consequently also reduced CO₂ emissions.

One variant of the present disclosure relates to a computer software product with a program code which is stored on a computer readable medium for actuating a drive device according to any one of the preceding embodiments. The torque generator drives the compressor unit temporally at least before the start of the combustion engine. The technical effects and advantages that may be realized with the computer software product according to the suggestion are analogous to those discussed with respect to the drive device according to the suggestion. In summary, it should be noted that the mass inertia and friction of the moving parts in the combustion engine and the moving parts in the drivetrain can be overcome more quickly when the combustion engine is started, with the result that the starting phase of the combustion engine can be shortened. These advantages may be realized particularly effectively in a cold start, because the engine oil is relatively viscous, and the friction described previously is particularly strong. However, the advantages may also be realized in a warm start, because the inertia and friction described earlier have to be overcome in these conditions too, though to a lesser degree than in a cold start. All of the technical effects and advantages described result either directly or indirectly in reduced fuel consumption and consequently also reduced CO₂ emissions.

In a further variant, the torque generator no longer drives the compressor unit during or after the start of the combustion engine. It has been found that most of the technical effects and advantages described in the preceding text can be achieved even if the compressor unit is only operated for a relatively short period of time. Thus, it is sufficient to activate the compressor unit by means of the torque generator for example 0.5 to 2 seconds before the combustion engine is started, but to deactivate the compressor unit again during or shortly after the start. In this context, the time for which the compressor unit is operated after the start may be shorter than the time before the start. The shorter the time for which the compressor unit in in operation, the less energy is required, which in turn lowers fuel consumption.

### BRIEF DESCRIPTION OF THE DRAWINGS

The present disclosure will hereinafter be described in conjunction with the following drawing figures, wherein like numerals denote like elements.

FIG. 1 is a schematic representation of an exemplary embodiment of a drive device according to the suggestion; and

FIG. 2 is a representation in the form of a block diagram of an embodiment for operating drive device.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

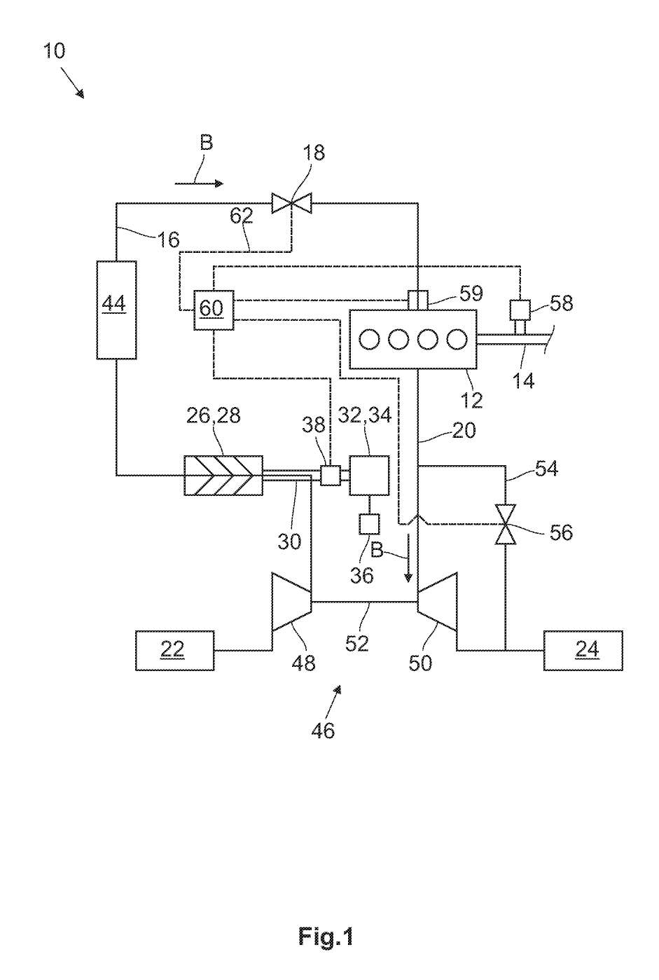

FIG. 1 is a schematic representation of a drive device 10 according to an embodiment for propelling a motor vehicle. Drive device 10 includes a combustion engine 12, for example a four-cylinder gasoline or diesel engine, which generates the power required for propelling the motor vehicle and delivers it to a crankshaft 14. Combustion engine 12 typically works according to the four-stroke principle, although a two-stroke principle is also conceivable. Drive device 10 includes a feed line 16, via which combustion engine 12 may be supplied with combustion air. A throttle valve 18 is arranged in feed line 16 and is movable between open position, in which it is fully open, and a closed position, which it is closed as far as possible. The exhaust gases that are created when the mixture of combustion air and fuel is combusted are transported out of combustion engine 12 via a drainage pipe 20. Combustion engine 12 may have a suction device 22 for drawing combustion air from the surrounding atmosphere, and which may include an air filter, for example. Drainage pipe 20 includes an exhaust gas treatment system 24, which may include catalytic converters and filters, particularly particulate filters, for filtering the toxic components contained in the exhaust gas and/or converting them into non-toxic compounds.

Drive device 10 includes a compressor unit 26, which cooperates with the combustion air in feed line 16, and compresses it. Compressor unit 26 includes a rotary compressor 28, which in the example shown is mechanically connected to a torque generator 32 via a connecting shaft 30, the torque generator in this case being an electric motor 34, by which torque generator 32 the compressor is driven. Drive device 10 further includes a storage device 36 for electrical energy, which is connected to electric motor 34.

Connecting shaft 30 cooperates with a coupling device 38, via which rotary compressor 28 may be optionally connected to electric motor 34. Coupling device 38 may be designed as an electromagnetic coupling device 38, for example.

An air cooler 44 is arranged downstream of compressor unit 26 for cooling the combustion air that heats up as it is compressed. Air cooler 44 is often also called a charge air cooler.

Drive device 10 also has a turbocharger device 46, which is arranged upstream from compressor unit 26 when seen in the direction of flow of combustion air to combustion engine 12. Turbocharger device 46 has a turbocompressor 48 arranged in feed line 16 and an exhaust gas turbine 50 arranged in drainage pipe 20, and these are connected to each other via a shaft 52. A waste gate line 54 is provided in drainage pipe 20, which may optionally be used to bypass exhaust gas turbine 50 of turbocharger device 46, and for which a control valve 56 is arranged in the waste gate line 54.

In order to start combustion engine 12, a starter 58 is provided that cooperates with crankshaft 14.

A pressure sensor 59 is provided in the inlet manifold to detect the pressure. A control unit 60 is also present, and is connected to pressure sensor 59 via electrical lines 62 and receives signals generated by the pressure sensor 59. Control unit 60 is also connected to throttle valve 18, coupling device 38, control valve 56 and starter 58 via electrical lines 62.

The direction of flow of the combustion air and the exhaust gases through feed line 16 and drainage pipe 20 is indicated by arrows B.

The drive device 10 is operated as follows. In the starting state, the entire drive device 10 should be switched off, as is the case when the motor vehicle has been parked in a car park or a garage for a prolonged period. When the driver wishes to use the motor vehicle (cold start), he or she actuates the ignition, thereby activating control unit 60, which first starts electric motor 34 and closes coupling device 38 then sets rotary compressor 28 of compressor unit 26 in motion. The rotation of rotary compressors 28 causes combustion air to be drawn in from the surrounding atmosphere and compressed to a predetermined pressure. In order to be able to compress the greatest possible volume of combustion air, it is advisable to position compressor unit 26 as far as possible from combustion engine 12, so that a greater volume of compressed combustion air can be introduced into feed line 16 upstream of compressor unit 26. Control unit 60 also causes throttle valve 18 to open, so that the compressed combustion air can enter combustion engine 12 without having to overcome any significant flow resistance. Control unit 60 now actuates starter 58, which sets crankshaft 14 in rotary motion. The rotation of crankshaft 14 causes the pistons to move inside the cylinders of the combustion engine 12 and the inlet valves to open allowing the compressed combustion air to flow into the cylinder combustion chambers. At the same time, fuel is injected and the compressed mixture of combustion air and fuel is ignited by spark plugs, thus setting combustion engine 12 in motion.

As soon as combustion engine 12 has been set in motion and crankshaft 14 has completed for example five revolutions, control unit 60 switches electric motor 34 off and opens coupling device 38, so that rotary compressor 28 is no longer driven. During the subsequent operation of the motor vehicle, coupling device 38 and electric motor 34 may be actuated by control unit 60 again in such manner that rotary compressor 28 is rotated again. Rotary compressor 28 is activated particularly during transitional states in which the combustion engine 12 must deliver a high load for a short time, as is the case particularly during acceleration maneuvers.

If traffic conditions make it necessary to stop the motor vehicle for a certain period of time, at a red traffic light or a closed level crossing for example, control unit 60 switches combustion engine 12 off. As soon as the driver instructs combustion engine 12 to output load again (warm start), particularly by releasing the clutch pedal and/or depressing the gas pedal, control unit 60 actuates coupling device 38 and electric motor 34 in such manner that rotary compressor 28 is rotated and the combustion air is compressed. As described previously, throttle valve 18 is opened by control unit 60 so that the combustion air can flow into combustion engine 12 largely unimpeded. Now, starter 58 is actuated, restarting combustion engine 12 as described earlier. As soon as combustion engine 12 has been restarted, coupling device 38 is opened and electric motor 34 is switched off,

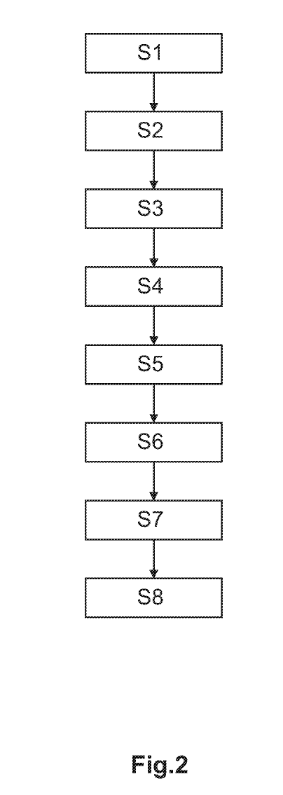

FIG. 2 is a representation in the form of a block diagram of one possible embodiment for operating drive device 10 according to the suggestion, wherein no limitation of any kind is intended, either with regard to the steps illustrated or to the sequence of the steps. In this context, in step S1 the ignition is activated. In step S2 control unit 60 is activated. In step S3 throttle valve 18 is opened, unless it is already open. In step S4 electric motor 34 is activated. In step S5 coupling device 38 is closed. In step S6 starter 58 is actuated. In step S7 coupling device 38 is opened again. In step S8 the electric motor is switched off again. The steps listed here relate to a cold start. In the case of a warm start, steps S1 and S2 are omitted. Time periods of varying length may separate the various steps.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-11. (canceled)

12. A drive device for a motor vehicle having a combustion engine, the drive device comprising:
a feed line configured to supply combustion air to the combustion engine;
a compressor unit cooperating with the feed line to provide compressed combustion air to the combustion engine,
a torque generators operable independently of the combustion engine and selectively coupled to the compressor unit for driving the compressor unit; and
a control unit configured to operate the torque generator in such manner that the torque generator drives the compressor unit for a time period prior to starting the combustion engine.

13. The drive device according to claim 12, wherein the torque generator comprises an electric motor operably connected to the compressor unit.

14. The drive device according to claim 12, wherein the control unit is configured to operate the torque generator in such manner that the torque generator stops driving the compressor unit after the start of the combustion engine.

15. The drive device according to claim 12, wherein the control unit is configured to operate the torque generator in such manner that the torque generator stops driving the compressor unit after the start of the combustion engine.

16. The drive device according to claim 12, further comprising a starter configured to start the combustion engine, wherein the control unit is configured to operate the torque generator and the starter in such manner that the torque generator drives the compressor unit for a time period during which the starter is operated to start the combustion engine and no longer drives the compressor unit once the combustion engine is started.

17. The drive device according to claim 12, further comprising a coupling device operable disposed between and selectively coupling the torque generator to the compressor unit.

18. The drive device according to claim 17, wherein the control unit is further configured to actuate the coupling device in such manner that the torque generator drives the compressor unit for a time period before the start of the combustion engine and no longer drives the compressor unit once the combustion engine is started.

19. The drive device according to claim 12, further comprising a turbocharger device with a turbocompressor and an exhaust gas turbine arranged in an exhaust line for driving the turbocompressor, wherein the turbocompressor cooperates with the feed line and is positioned upstream of the compressor unit relative to a direction of supply of the combustion air.

20. A motor vehicle having a drive device according to claim 12.

21. A non-transitory computer readable medium comprising a program code, which when executed on a computer, is configured to actuate a drive device such that a torque generator drives a compressor unit temporally at least before the start of the combustion engine.

22. The non-transitory computer readable medium according to claim 21, further comprising a program code, which when executed on a computer, is configured to cease driving the torque generator the compressor unit after the start of the combustion engine.

23. The non-transitory computer readable medium according to claim 21, further comprising a program code, which when executed on a computer, is configured to operate the torque generator in such manner that the torque generator drives the compressor unit for a time before the start of the combustion engine and ceases driving the compressor unit after the start of the combustion engine.
